(19) United States
(12) Patent Application Publication
(10) Pub. No.: US 2005/0261871 A1
(43) Pub. Date: Nov. 24, 2005

(54) Automatic weight and measures computing device and method

(75) Inventor: Chih-Cheng Chien, Shenkeng Township (TW)

Correspondence Address: BACON & THOMAS, PLLC, 625 SLATERS LANE, FOURTH FLOOR, ALEXANDRIA, VA, 22314, US

(73) Assignee: Kinpo Electronics, Inc., Taipei (TW)

(21) Appl. No.: 10/939,494

(22) Filed: Sep. 14, 2004

(30) Foreign Application Priority Data
May 21, 2004 (TW) 093114429

(51) Int. Cl. G06F 15/02

(52) U.S. Cl. 702/173

(57) ABSTRACT

An automatic weight and measures computing device and method includes: a storage unit, an input device, an input device, a display device and a control device. The storage unit is used for storing a plurality of operational formulas. When an input signal of a selected operational formula is received, the selected operational formula is displayed on the display unit. The input unit inputs values corresponding to parameters according to the selected operational formula, and then the control unit provides an operational result according to the selected operational formula and the input values and displays the operational result in the value display area. The present invention can also be combined with a measuring tool to directly read the measurement value from the measuring tool as an input value.

### BACKGROUND OF THE INVENTION

1. Field of the Invention

The present invention relates to a commercial electronic product, and more particularly, to an automatic weight and measures computing device and method.

2. Description of the Related Art

Generally, a computing device supports basic logic operations, such as addition, subtraction, multiplication, and division, and may support other more complicated operations. However, a user must memorize various formulas to calculate an area or volume of a target object so that he or she may input different parameters required by the formula. Generally, the user cannot immediately obtain the area or volume of a target object after performing a measuring process, and instead must manually input the measurement results into the memorized formula.

However, it is not easy to memorize all of the formulas for the various shapes, and the user may forget to input every parameter in the formula. Furthermore, the prior art computing device does not error-check the values input by the user.

Therefore, it is desirable to provide an automatic weight and measures computing device and method to mitigate and/or obviate the aforementioned problems.

### SUMMARY OF THE INVENTION

According to an aspect of the present invention, an automatic weight and measures computing device comprises: a storage unit, an input device, an input device, a display device and a control device. The storage unit is used for storing a plurality of operational formulas, and each operational formula being composed of at least two parameters and at least one logical operator; the input device comprises: a set of number buttons for inputting at least one number; a set of symbol buttons for inputting at least one logical operator; a set of selection buttons for selecting an operational formula; and a confirmation button for confirming input data; the display unit comprises a value display area for displaying values; and a formula display area for displaying the selected operational formula; and the control unit is used for executing a mathematical operational formula. The automatic weight and measures computing device is characterized in that the input unit inputs values corresponding to parameters according to the selected operational formula, and then the control unit provides an operational result according to the selected operational formula and the input values and displays the operational result in the value display area.

According to another aspect of the present invention, an automatic weight and measures computing method for the above-mentioned device comprises the steps of: receiving an input signal of a selected operational formula; receiving at least two parameters and at least one logical operator defined by the operational formula; displaying the operational formula; receiving input signals corresponding to values for the parameters; determining a result according to the operational formula and the input values; and displaying the result.

The automatic weight and measures computing device and method of the present invention provides a graphic interface for operational formulas and can be combined with a suitable measuring tool to directly receive measurement values as the input values. Furthermore, the present invention can contain a unit transformation means.

Other objects, advantages, and novel features of the invention will become more apparent from the following detailed description when taken in conjunction with the accompanying drawings.

### BRIEF DESCRIPTION OF THE DRAWINGS

FIG. 1 is a functional block drawing of a preferred embodiment according to the present invention;

FIG. 2 is an operational formula list of the preferred embodiment according to the present invention;

FIG. 3 is a schematic drawing of a computing device of the preferred embodiment according to the present invention;

FIG. 4 is a flowchart of the preferred embodiment according to the present invention;

FIG. 5 is a schematic drawing of a first aspect of the embodiment according to the present invention;

FIG. 6 is a schematic drawing of a second aspect of the embodiment according to the present invention; and

FIG. 7 is a schematic drawing of a third aspect of the embodiment according to the present invention.

### DETAILED DESCRIPTION OF THE PREFERRED EMBODIMENT

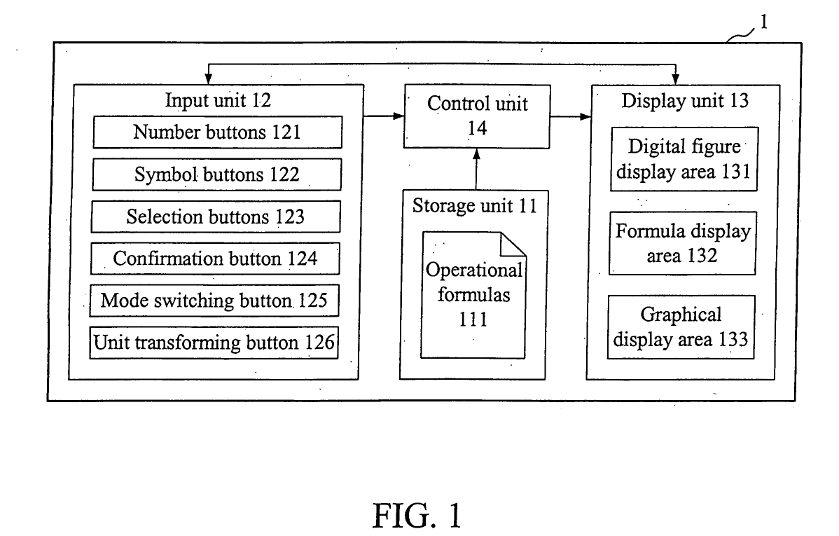

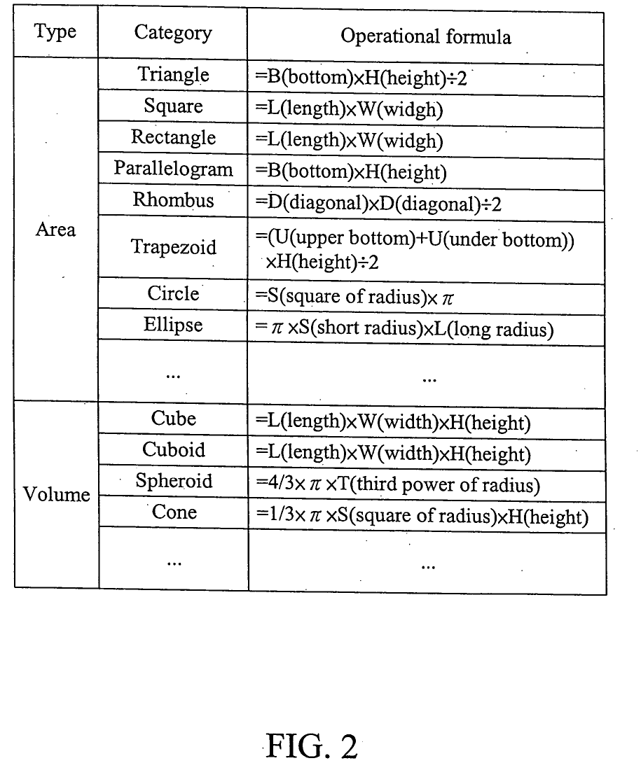

Please refer to FIG. 1. FIG. 1 is a functional block drawing of a preferred embodiment according to the present invention. A computing device 1 comprises a storage unit 11, an input unit 12, a display unit 13, and a control unit 14. The storage unit 11 stores a plurality of operational formulas 111, and every operational formula 111 is composed of at least two parameters and at least one logical operator. As illustrated by an operational formula list shown in FIG. 2, in this embodiment the storage unit 11 stores different area operational formulas and volume operational formulas; for example, the operational formula for the area of a triangle, “B×H÷2”, is stored in the storage unit 11, wherein B is a bottom side of the triangle, H is a height of the triangle; as another example, the operational formula for the volume of a cube, “L×W×H”, is stored in the storage unit 11, wherein L is length, W is width, and H is height. Of course, the operational formulas 111 stored in the storage unit are numerous, and may be added or deleted easily. The control unit 14 is mainly used for executing a mathematical operational process.

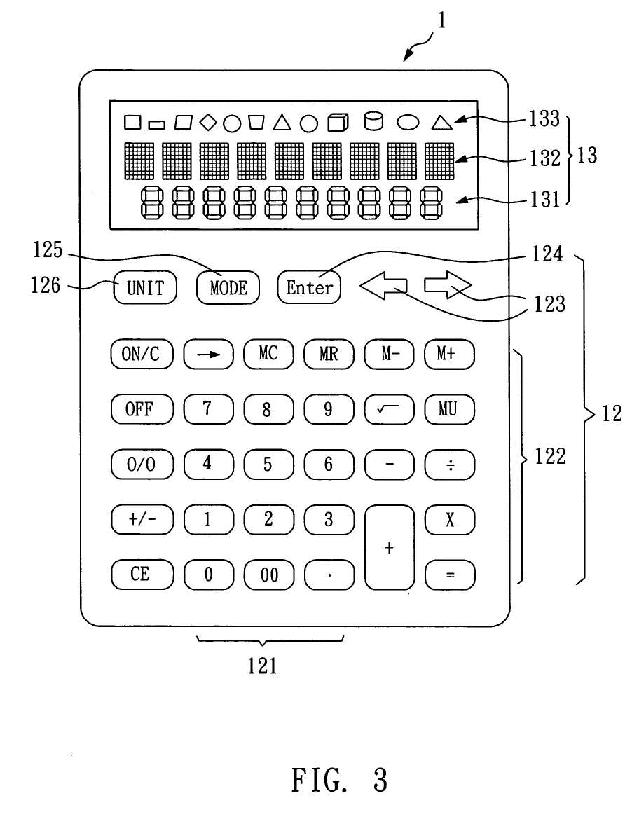

Please refer to FIG. 3. FIG. 3 is a schematic drawing of a computing device of the preferred embodiment of the present invention. A user interface for the input unit comprises: basic number buttons 121 (from 0 to 9), symbol buttons 122 (such as “+”, “−”, “×” and “÷”), a set of selection buttons 123, a confirmation button 124, a mode switching button 125 and a unit transformation button 126. The display unit 13 is divided into a digital figure display area 131 for displaying digital figures, a formula display area 132 for displaying the operational formula 132, and a graphical display area 133 for displaying different two-dimensional or three-dimensional target objects such as a triangle, rectangle or column, and every graph corresponds to an operational formula 111 stored in the storage unit 11.

Subsequently, when the computing device 1 receives a signal indicating that the mode switching button 125 has been pressed, it changes from a basic operational mode into a formula mode (or called a weight and measures mode) to receive an operational selection signal from the selection button 123. In this embodiment, the set of selection buttons 123 includes a left button and a right button, and the graphical display area 133 displays the graphic selected by the selection buttons 123, for example, by highlighting the selected graphic. After selection the graphic, the computing device 1 reads the corresponding operational formula 111 from the storage unit 11 and displays the operational formula 111 in the formula display area 132. Alternatively, the selection buttons 123 may also be a single button, or a set of up, down, right and left buttons; the graphical display area 133 may have different graphic arrangements according to the display unit 13. Furthermore, the formula display area 132 preferably displays the English name of the figure, and the formula display area 132 may also display the definition of each parameter. For example, when the formula display area 132 displays the formula “B×H”, and when a cursor is moved to “B”, the definition of “B” is displayed as the “bottom” of the triangle.

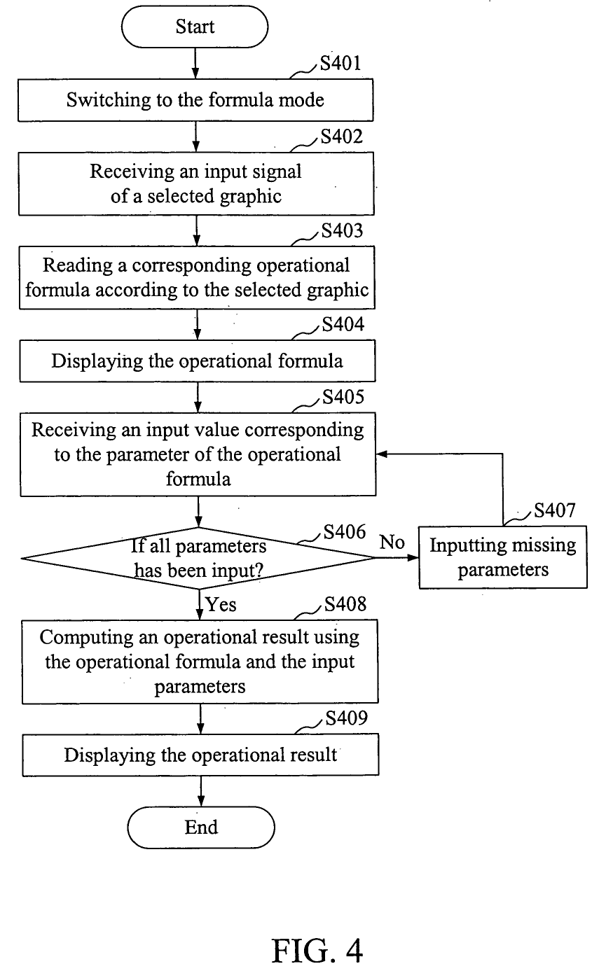

Please refer to FIG. 4. FIG. 4 is a flowchart of the preferred embodiment according to the present invention. When receiving a signal indicating that the mode switching button 125 has been pressed, the computing device 1 switches to the formula mode (step S401) and allows a user to select a corresponding graphic of the target object in the graphical display area 133 by using the selection buttons 123 (step S402). Since in this embodiment the target object is the area of a rectangle, the computing device 1 reads from the storage unit 11 (step S403) the operational formula “L×W” corresponding to the area for a rectangle and displays the operational formula in the formula display area 132 (step S404). Moreover, the computing device 1 receives an input signal for a figure corresponding to the length (L) parameter (step S405). The number buttons 121 are used for inputting a length parameter, and the confirmation button 124 is used for finishing the input process. In this embodiment, after finishing the input of one parameter, the formula display area 132 displays the input parameter with an underline to indicate to the user which parameter has been input. Of course, the input parameters can be marked in a different manner, or may simply not be marked at all. The control unit 14 of the computing device 1 initiates an error detection means to determine whether the operational formula has been completely input (step S406); if there are any missed parameters, the computing device 1 must then input the missing parameters (step S407). After all parameters have been input, the control unit 14 then computes an operational result using the operational formula and the input parameters (step S408). Finally, the digital figure display area 131 displays the operational result (step S409). The input sequence of the parameters may correspond to the definition of the operational formula, or to another sequence controlled by the selection buttons 123. Moreover, the formula display area 132 should display the definition of the parameter before the parameter is input to reduce error.

The computing device 1 of the embodiment can be combined with a unit transforming means so that the unit transforming button 126 can transform the input parameters into the units required by the definition of parameters to more accurately calculate areas or volumes.

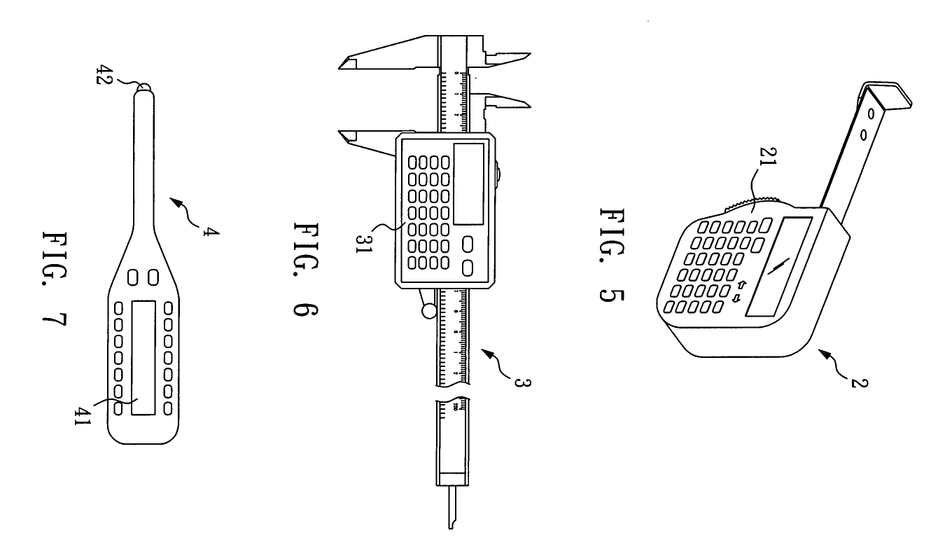

In the above-mentioned embodiment, the computing device 1 utilizes the number buttons 121 to input the values corresponding to the parameters. However, the computing device can also be combined with a measuring tool to directly read the measurement value from the measuring tool as an input value. A measuring tape 2 shown in FIG. 5 can provide a length measurement as a parameter value for a computing device 21. calipers 3 shown in FIG. 6 can also provide a length measurement as a parameter value for a computing device. A measuring pen 4 can measure length by a front-end sensor 42 and provide the measurement as a parameter value for a computing device 41.

According to the above-mentioned description, the weight and measures automatic computing device and method of the present invention stores many operational formulas to avoid memorization of the operational formulas and user errors. The present invention further provides the error detection means for increasing user input accuracy, and for ensuring that all parameters are input completely. The present invention provides a graphical interface for displaying a corresponding formula according to a selected graphic. Moreover, the present invention can be combined with a suitable measuring tool to directly receive measurement values as the input values, which simplifies the input process and increases the operational utility of the present invention. The computing device can contain a unit transformation means. The computing device may also use well-known function buttons to provide new functionality; for example, the confirmation button can also be the “=” button, so that manufacturing costs can be reduced.

Although the present invention has been explained in relation to its preferred embodiment, it is to be understood that many other possible modifications and variations can be made without departing from the spirit and scope of the invention as hereinafter claimed.

1. An automatic weight and measures computing device comprising:
a storage unit for storing a plurality of operational formulas, each operational formula being composed of at least two parameters and at least one logical operator;
an input device comprising:
a set of number buttons for inputting at least one number;
a set of symbol buttons for inputting at least one logical operator;
a set of selection buttons for selecting an operational formula; and
a confirmation button for confirming input data;
a display unit comprising:
a value display area for displaying values; and
a formula display area for displaying the selected operational formula; and
a control unit for executing a mathematical operational formula;
wherein the automatic weight and measures computing device is characterized in that the input unit inputs values corresponding to parameters according to the selected operational formula, and then the control unit provides an operational result according to the selected operational formula and the input values and displays the operational result in the value display area.

2. The automatic weight and measures computing device as claimed in claim 1, wherein the input unit is connected to a measuring unit for receiving the value measured by the measuring unit.

3. The automatic weight and measures computing device as claimed in claim 1, wherein the display unit includes a graphical display area for displaying a target object corresponding to the operational formula.

4. The automatic weight and measures computing device as claimed in claim 1, wherein the formula display area is used for displaying definitions of the parameters of the operational formula.

5. The automatic weight and measures computing device as claimed in claim 1, wherein in the formula display area, a confirmed input parameter is underlined.

6. The automatic weight and measures computing device as claimed in claim 1, wherein the control unit has an error detection means, and after the error detection means verifies all of the input values corresponding to the operational formula, the control unit then calculates an operational result according to the operational formula and the input values.

7. The automatic weight and measures computing device as claimed in claim 1, wherein the input unit comprises a mode switching button for switching into a formula mode for the operational formula selected by the selection buttons.

8. The automatic weight and measures computing device as claimed in claim 1, wherein the input unit comprises a unit transformation button for converting the values into different values corresponding to a unit used in the operational formula.

9. An automatic weight and measures computing method comprising the steps of:
(A) receiving an input signal of a selected operational formula;
(B) receiving at least two parameters and at least one logical operator defined by the operational formula;
(C) displaying the operational formula;
(D) receiving input signals corresponding to values for the parameters;
(E) determining a result according to the operational formula and the input values; and
(F) displaying the result.

10. The automatic weight and measures computing method as claimed in claim 9, wherein step (A) further comprises: receiving an input signal of a selected graphic, the graphic corresponding to an operational formula.

11. The automatic weight and measures computing method as claimed in claim 9, wherein in step (D), the input signals of the values are measurement values provided by a measuring device.

12. The automatic weight and measures computing method as claimed in claim 9, wherein step (E) further comprises: determining a result according to the operational formula and the input values.

13. The automatic weight and measures computing method as claimed in claim 9, wherein confirmed input parameters are underlined.
